(19) United States
(12) Patent Application Publication
(10) Pub. No.: US 2025/0206664 A1
(43) Pub. Date: Jun. 26, 2025

(54) Shaped Aggregate Reinforcements for Concrete

(71) Applicant: MAA'VA Inc., San Francisco, CA (US)

(72) Inventors: Marieh Mehrannnezhad, San Francisco, CA (US); Monika Bleszynski, Denver, CO (US); Russell Brand, Redwood City, CA (US); Torrey Smith, Redwood City, CA (US)

(21) Appl. No.: 18/849,064

(22) PCT Filed: Mar. 21, 2023
(86) PCT No.: PCT/US2023/015739

§ 371 Date: Sep. 20, 2024

Related U.S. Application Data
(60) Provisional application No. 63/322,193, filed on Mar. 21, 2022.
(60) Provisional application No. 63/478,873, filed on Jan. 6, 2023.

(51) Int. Cl. C04B 18/02; B33Y 80/00; C04B 14/06; C04B 16/12; C04B 18/20

(52) U.S. Cl. CPC C04B 18/022; C04B 14/06; C04B 16/12; C04B 18/20; B33Y 80/00; C04B 2201/50

(57) ABSTRACT

The present disclosure relates generally to shaped aggregate particles and reinforcement for concrete. Specifically, but without limitation, the disclosure relates to plastic shaped aggregate particles. The plastic shaped aggregate particles may be made of/from recycled plastic. Such shaped aggregate particles may contain recycled and non-recycled glass fibers and particles, silica, or similar materials and/or combinations. The morphologies of the shaped aggregate particles include, but are not limited to, spherical particles, spiral structures, elongated ellipsoids, fibers, connected structures, spherical burst patterns, or similar structures such as tetrahedrons, rectangular prisms, and pyramids. The shaped aggregate particles may be made of recycled plastic waste and used with and without discontinuous glass fibers and/or similar materials such as chopped glass fibers and glass particles, for use in concrete applications as a filler and support.

### CROSS REFERENCES TO RELATED APPLICATIONS

The present application is a national phase entry under 35 U.S.C. § 371 of International Patent Application PCT/US2023/015739, filed Mar. 21, 2023, designating the United States of America and published in English as International Patent Publication WO 2023/183282 on Sep. 28, 2023, which claims priority to U.S. Provisional Patent Application No. 63/322,193 entitled “Shaped Aggregate Reinforcements for Concrete,” filed on Mar. 21, 2022, and U.S. Provisional Patent Application No. 63/478,873 entitled “Shaped Aggregate Reinforcements for Concrete,” filed on Jan. 6, 2023. The entirety of each of which are incorporated by reference herein.

### TECHNICAL FIELD

The present disclosure relates generally to shaped aggregate particles and reinforcement for concrete. Specifically, but without limitation, the disclosure relates to plastic shaped aggregate particles. The plastic shaped aggregate particles may be made of/from recycled plastic. Such shaped aggregate particles may contain recycled and non-recycled glass fibers and particles, silica, or similar materials and/or combinations. The morphologies of the shaped aggregate particles include, but are not limited to, spherical particles, spiral structures, elongated ellipsoids, fibers, connected structures, spherical burst patterns, or similar structures such as tetrahedrons, rectangular prisms, and pyramids.

The shaped aggregate particles may be made of recycled plastic waste and used with and without discontinuous glass fibers and/or similar materials such as chopped glass fibers and glass particles, for use in concrete applications as filler and support.

### BACKGROUND

Aggregates in concrete are used as filling agents and to increase the mechanical strength of the final concrete product [1-3]. Standard aggregates for concrete are made of stones and crushed rock, and over 48.3 billion metric tons of aggregate were used in 2015 alone [1-3]. Meanwhile, the societal use of plastic is increasing, with an estimated 313 million tons of plastic produced in 2014, and that same year, 59 million tons of plastic waste were disposed. Recycling is unfortunately not a complete solution, as only 8.9% of plastic waste was recycled in the United States in 2012, with the majority of plastic sent to landfill [1-3].

As a potential non-recycling “re-use” solution, non-recyclable plastics can be incorporated into concrete as an aggregate [1-5], and the incorporation of recycled plastic aggregates may offer beneficial properties or improve the existing characteristics of concrete materials. For example, a study by Choi et al. noted that when spherical and smooth surface waste plastic polyethylene terephthalate (PET) aggregate was used in concrete at a replacement level of 75%, the slump increased by 46% compared to standard concrete [5]. A study by Mohammed et al. foundthat plastic aggregate derived from PVC sheets could be incorporated into concrete, with a replacement rate of 30%, without significantly affecting concrete strength [3]. Furthermore, the researchers found that PVC exhibited a relatively good size distribution effect compared to the other plastics. Another study by Alqahtani et al. showed that concrete containing manufactured plastic aggregate exhibited ductile post-peak behavior, at a replacement of 25% [4]. Therefore, this type of concrete containing mixed plastic aggregate could be used for structural and non-structural applications that require reasonable strength and ductility [1-5].

Plastic aggregate can be incorporated into concrete in the form of shredded, chopped, or formed plastic, though most designs utilize either shredded plastic or plastic pellets, which can be round, ellipsoidal, or approximately cylindrical [1-7]. For example, Arqlite SmartGravel™ utilizes recycled plastic as an aggregate in the shape of a rounded cylinder, which has a smooth surface and no additional surface characteristics or features [8].

### SUMMARY

Certain plastics, when incorporated into cement to create concrete, possess more low-energy molecular interactions with the cement particles, increasing the likelihood of a stronger interface in the final concrete material. As a result, certain plastics, namely PVC, HDPE, epoxy, polyester, and nylon, are suitable for incorporation into cement as aggregates to create concrete and will exhibit stronger interactions with the surrounding cement matrix, resulting in a stronger overall concrete material.

In a first aspect, the disclosure provides a composition. The composition includes a plurality of shaped aggregate particles distributed within a mixture of cement; wherein each shaped aggregate particle comprises a regular shape with one or more features providing additional surface area, and wherein the shaped aggregate particles comprise a plastic.

In a second aspect, the disclosure provides a method for producing concrete. The method includes mixing a plurality of the shaped aggregate particles with a cement mixture, wherein the cement mixture comprises cement and one or more additional components.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 depicts a spherical shaped aggregate particle having a tapered design, where the fins meet at a point, at the north and south poles of the sphere.

FIG. 2 depicts a spherical shaped aggregate particle having a tapered design, where the fins meet at a point, at the north and south poles of the sphere.

FIG. 3 depicts a spherical shaped aggregate particle having an offset design, with more ribbing on the exterior and a hollow core intersected by ribs that extend from the north and south poles.

FIG. 4 depicts a spherical shaped aggregate particle having protrusions from the spherical center.

FIG. 5 depicts a spiral shaped aggregate particle.

FIG. 6 depicts aggregate particles produced by extrusion.

FIG. 7 depicts aggregate particles produced by extrusion and shaped through cutting the extrusion.

FIG. 8 depicts aggregate particles produced by extrusion and cut at different temperatures.

FIG. 9 depicts a 2-dimensional woven textile structure.

FIG. 10 depicts a 3-dimensional woven textile structure.

FIG. 11A depicts a side view of a cement paver with plastic shaped aggregate particles having a rectangular geometry with rounded corners to offset corner stresses.

FIG. 11B depicts a top view of the cement paver of FIG. 11A.

FIG. 12 depicts woven aggregates within poured concrete.

FIG. 13 depicts aggregate particles of interlocking rings.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The present disclosure provides a disclosure for new shaped aggregate particles. In embodiments, the shaped aggregate particle comprises a regular shape and one or more features in additional to regular shape the provide additional surface area to the regular shape.

As used herein, “shaped” refers to a consistent geometry where the differences between particle being “shaped” the same have less than 5% incongruence between the particles. As such, “shaped” refers to a non-random form that is selected for having a particular geometry.

As used herein, a “regular shape” is geometrical shape that forms the overall impression of an aggregate particle. Examples of “regular shapes” include, but are not limited to, spheres, cylinders, rods, cones, cubes, cuboids, pyramids, prisms, regular and irregular polyhedrons, spirals, closed spirals, open spirals, helices, toruses, ellipsoids, elongate ellipsoids, spherical burst patters, stars, and fibers.

As used herein, “features” are alterations to the regular shape that increase the surface area of the regular shape. As such, “features” may be cavities or voids on the surface of the regular shape, including voids that pass completely through the regular shape, protrusions or other bodies on the regular shape that serve to increase the surface area. Examples of “features” include, but are not limited to, fins, ribs, twists, bends, ridges, valleys, hollow cores, and weaves.

The shaped aggregate particles may be formed by injection molding, compression molding, weaving, pultruding, extruding, 3D printing, knitting, or produced through similar methods. In embodiments, the shaped aggregate may comprise a plastic. In particular embodiments, the plastic may be recycled plastic.

The plastic may be any plastic or combination of plastics. A combination of plastics may contain solely new plastic, solely recycled plastic, or a combination of new and recycled plastic. In particular embodiments, the plastic may be selected from PVC, HDPE, polyester/PET, epoxy, and nylon, and combinations thereof. The plastic may further contain additives, fillers, stabilizers, and/or similar materials.

In particular embodiments, the shaped aggregate particle may comprise up to 100% plastic. Certain shaped aggregate particles may comprise about 1%, 2%, 3%, 4%, 5%, 6%, 7%, 8%, 9%, 10%, 20%, 25%, 30%, 35%, 40%, 45%, 50%, 45%, 60%, 65%, 70%, 75%, 80%, 85%, 90%, 95%, or 100%, by volume plastic. The shaped aggregate particle may comprise at least 65% plastic. The shaped aggregate particle may comprise at least 75% plastic. The shaped aggregate particle may comprise from about 65% to about 75% plastic.

In certain embodiments, the shaped aggregate particles may further comprise glass fiber, discontinuous glass fiber, glass particles, silica, or any combination thereof. The glass fiber, discontinuous glass fiber, glass particles, silica may range in size from 100 μm to 100 mm in size. The glass fiber, discontinuous glass fiber, glass particles, silica may all be of substantially the same size or may be a plurality of different sizes in any particular aggregate particle. In embodiments, the size of the particles may be about 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm. In corporation of glass fiber, discontinuous glass fiber, glass particles, silica or any combination thereof may provide increased mechanical strength, increased number of potential bonds with the cement binder, as well as other benefits to the shaped aggregate particle.

In particular embodiments, the shaped aggregate particle may comprise up to 80% glass fiber, discontinuous glass fiber, glass particles, silica, or any combination thereof by volume. Certain shaped aggregate particles may comprise about 1%, 2%, 3%, 4%, 5%, 6%, 7%, 8%, 9%, 10%, 20%, 25%, 30%, 35%, 40%, 45%, 50%, 55%, 60%, 65%, 70%, 75%, or 80% by volume glass fiber, discontinuous glass fiber, glass particles, silica, or any combination thereof. The shaped aggregate particle may comprise at least 25% silica. The shaped aggregate particle may comprise at least 35% silica.

The shaped aggregate particles may be in the form of spherical particles, spiral structures, elongated ellipsoids, fibers, connected structures, and spherical burst patterns, or similar structures. Spherical aggregate particles may incorporate finned and/or ribbed features, to impart much higher surface area compared to traditional spherical aggregate particles. We have shown that through specific compositions and engineering, shaped aggregate particles can be successfully incorporated into cement to create viable concrete materials.

The spherical aggregate particles may roughly spherical and being approximately 1 mm to 50 mm in diameter. Certain spherical aggregate particles may be about 1 mm, 2 mm, 3 mm, 4 mm, 5 mm, 6 mm, 7 mm, 8 mm, 9 mm, 10 mm, 20 mm, 25 mm, 30 mm, 35 mm, 40 mm, 45 mm, or 50 mm in diameter.

The spherical aggregate particles may include features such as varying finned structures extending from the north and south poles of the spheroid particles, and the number of fins may vary, depending on the size of the shaped aggregate particle.

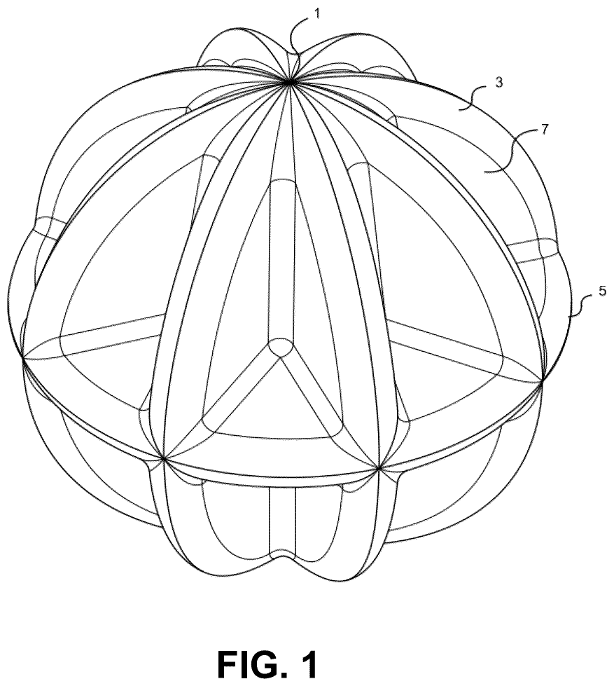

Smaller spherical aggregate particles such as FIGS. 1 and 2 may have a tapered design, where the fins meet at a point, at the north and south poles of the sphere. FIG. 1 depicts a spherical aggregate particle which includes eight longitudinal fins, such as fin 1. The longitudinal fins meet at the poles, such as north pole 3. Additionally, the aggregate particles include equatorial fin 5 which circles the aggregate particle, midway between the poles. The arrangement of the fins creates spaces between them, such as space 7. The spaces enable ingress of the cement.

FIG. 2 depicts a spherical aggregate particle which includes twelve longitudinal fins, such as fin 201. The longitudinal fins meet at the poles, such as north pole 203. Additionally, the aggregate particles include equatorial fin 205 which circles the aggregate particle, midway between the poles. The arrangement of the fins creates spaces between them, such as space 207.

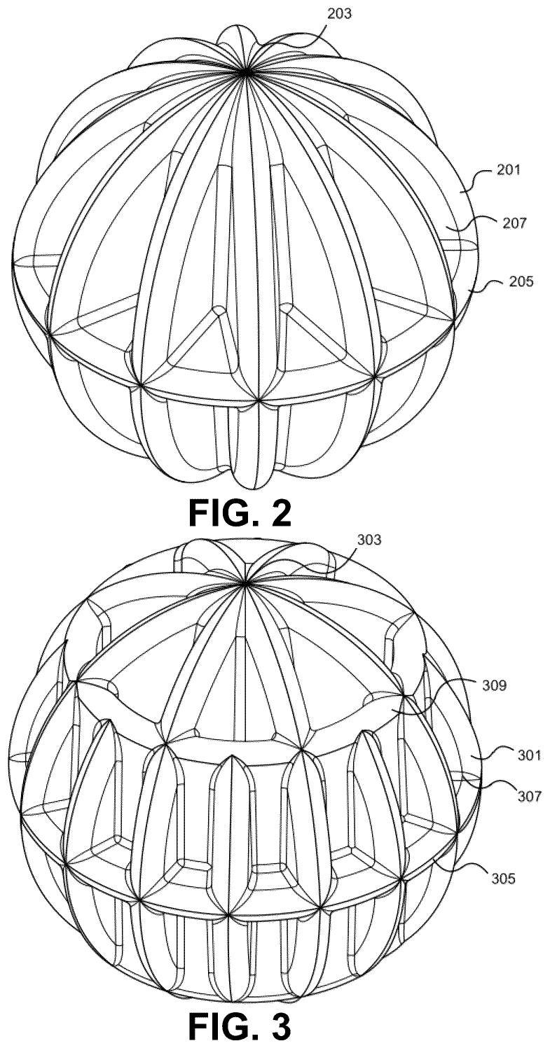

Larger plastic shaped aggregate particles may have an offset design, with more ribbing on the exterior and a hollow core intersected by ribs that extend from the north and south poles. FIG. 3 depicts a spherical aggregate particle with eight longitudinal fins, such as fin 301, which meet at the poles, such as north pole 303. Additionally, the aggregate particles include equatorial fin 305 which circles the aggregate particle, midway between the poles. Additional, latitudinal fins, such as latitudinal fin 209, circle the aggregate particle between the equatorial fin and the poles. The arrangement of the fins creates spaces between them, such as space 207.

The fins, and the spaces between them, offer several advantages over other plastic aggregate designs, namely smooth spherical, ellipsoidal, and cylindrical shapes, in terms of surface area and potential interfacial interactions. For example, a spherical finned aggregate particle of 10 mm considerably increases its surface area compared to a smooth faced design, with a surface area of 608 mm² for the spherical finned aggregate particle, while a standard smooth sphere would have a surface area of 236.97 mm² for the same volume (343 mm³). Therefore, the surface area of the designed finned plastic aggregate particle may be more than twice that of a sphere with the same volume and diameter. The increased surface area of the finned plastic aggregate particles allows for greater potential molecular interactions with the cement particles in the concrete, allowing for better adhesion. In embodiments, the regular shaped aggregate particles having features described herein may have increased surface area as compared to aggregate particles of the same regular shape but lacking features. In particular embodiments, the regular shaped aggregate particles having features described herein have an increased surface area ratio as compared to the compared to aggregate particles of the same regular shape but lacking features of at least 1.2×, at least 1.5×, at least 2×. at least 2.2× or at least 2.5×.

Larger aggregates often result poor in strength and decreased compression strength of the concrete material. As an additional means to combat this the aggregate particle described herein may incorporate a hollow design, to provide reinforcement. Specifically, larger shaped aggregate particles, such as a 10 mm diameter or larger plastic shaped aggregate particles may contain a hollow core (e.g., FIG. 3), where the cement could pass completely through the particle, allowing the cement to act as a reinforcement for the larger aggregate particles. This also provides additional surface area for interfacial interactions with the cement, while also providing a reinforcement effect.

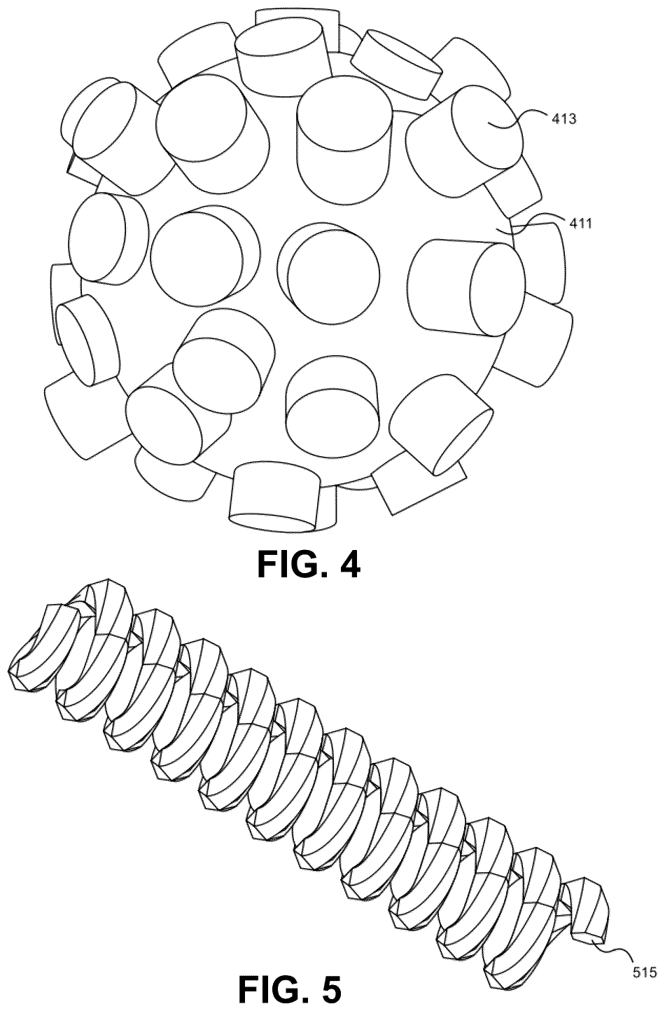

A shaped aggregate particle or a burst pattern or similar design may comprise spherical, ellipsoidal, or similar regular shape having numerous protrusion features, offering an increased surface area compared to a standard sphere. FIG. 4 depicts a shaped particle with a spherical base 411 and cylindrical protrusions 413. The protrusion features may be of any shape or size, such as cylinders, knobs, cones, etc.

A spiral aggregate particle, or similar design, may be a closed spiral or an open spiral. In embodiments, such as FIG. 5, the spiral aggregate particles are 10 to 25 mm in length. Certain spiral aggregate particles may be about 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, or 25 mm in length. In embodiments, the spiral aggregate particles are 1 to 10 mm in diameter. Certain spiral aggregate particles may be about 1 mm, 2 mm, 3 mm, 4 mm, 5 mm, 6 mm, 7 mm, 8 mm, 9 mm, or 10 mm in diameter. In a particular embodiment, the spiral aggregate particle is a closed spiral that surrounds a hollow interior space.

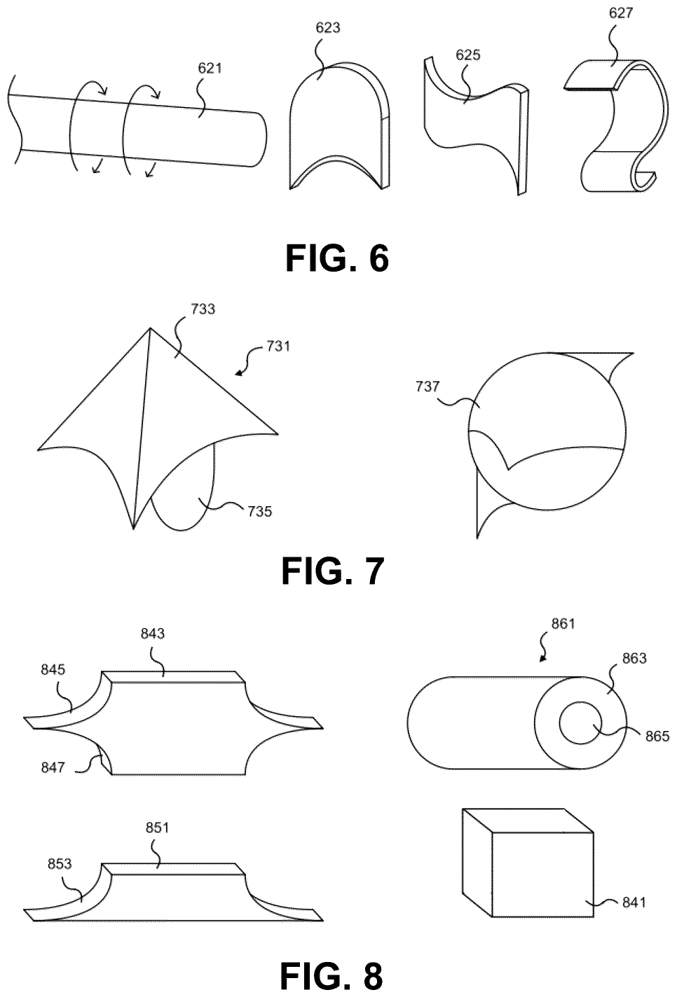

Other particle shapes may be produced as seen in FIGS. 6-8 including tooth, sail shaped, s-shaped, trefoil, stacked shapes, spheres with protrusions, cubes, dumplings, ramps, and bead shapes. Many of these shapes are formed through extrusion and cutting of the extruded fibers.

The shaped aggregate particles may comprise plastic fibers. Such plastic fibers may be rods of various shapes, including cylindrical, triangular, rectangular, or hexagonal. In embodiments, such plastic fibers may be from about 1 to about 1,000 mm in length. Certain plastic fibers may be about 1 mm, 2 mm, 3 mm, 4 mm, 5 mm, 6 mm, 7 mm, 8 mm, 9 mm, 10 mm, 20 mm, 25 mm, 30 mm, 35 mm, 40 mm, 45 mm, 50 mm, 60 mm, 70 mm, 80 mm, 90 mm, 100 mm, 200 mm, 300 mm, 400 mm, 500 mm, 600 mm, 700 mm, 800 mm, 900 mm, or 1000 mm in length. In embodiments, such plastic fibers may be from about 1 to about 100 mm in diameter. Certain plastic fibers may be about 1 mm, 2 mm, 3 mm, 4 mm, 5 mm, 6 mm, 7 mm, 8 mm, 9 mm, 10 mm, 20 mm, 25 mm, 30 mm, 35 mm, 40 mm, 45 mm, 50 mm, 60 mm, 70 mm, 80 mm, 90 mm, or 100 mm in diameter.

In certain embodiments, the plastic fibers may further comprise glass fiber, discontinuous glass fiber, glass particles, silica, or any combination thereof. The glass fiber, discontinuous glass fiber, glass particles, silica may range in size from 100 μm to 100 mm in size. The glass fiber, discontinuous glass fiber, glass particles, silica may all be of substantially the same size or may be a plurality of different sizes in any particular aggregate particle. In embodiments, the size of the particles may be about 0.1 mm, 0.2 mm, 0.3 mm, 0.4 mm, 0.5 mm, 0.6 mm, 0.7 mm, 0.8 mm, 0.9mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm. Incorporation of glass fiber, discontinuous glass fiber, glass particles, silica or any combination thereof may provide increased mechanical strength, increased number of potential bonds with the cement binder, as well as other benefits to the plastic fibers.

In particular embodiments, the plastic fibers may comprise up to 80% glass fiber, discontinuous glass fiber, glass particles, silica, or any combination thereof by volume. Certain shaped aggregate particles may comprise about 1%, 2%, 3%, 4%, 5%, 6%, 7%, 8%, 9%, 10%, 20%, 25%, 30%, 35%, 40%, 45%, 50%, 55%, 60%, 65%, 70%, 75%, or 80% by volume glass fiber, discontinuous glass fiber, glass particles, silica, or any combination thereof. The plastic fibers may comprise at least 25% silica. The plastic fibers may comprise at least 35% silica.

In embodiments, the shaped aggregate particles and/or plastic fibers of different sizes, particularly those with hollow structures, or similar designs, may be interlocked together to create a continuous structure, which could then be incorporated into concrete to improve the tensile strength of the concrete material.

Further disclosed herein are shaped aggregate particles in the form of textile structures in the form of woven mats in either 2D or 3D forms. These may provide additional benefits for concrete, namely improvements in tensile strength, resistance to impact, and flexibility.

A first woven structure may consist of a 2D woven textile structure. The textile structure may comprise any of the previously described plastic fibers. These 2D woven textile structures may comprise a two-dimensional weaving pattern. Examples of weaving patters include, but are not limited to, plain, twill, satin, triaxial, stitched, basket weaves, or other weave designs. These woven textile structures may be incorporated into the concrete either individually or as layers, forming plies (e.g., FIG. 6). The welt tow, warp tow, or z tow would be composited entirely of the aforementioned plastic fibers. The woven textile structures may further comprise a reinforcement of, for example, glass fibers tows.

The welt tow, warp tow, or z tow may be cylindrical or flat, from 1 mm to 100 mm in diameter and 1 mm to 10 m in length, in any combination thereof. In certain embodiments, the welt tow, warp tow, and/or z tow may be 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm in length. In combination, the welt tow, warp tow, and/or z tow may be 1 mm, 2 mm, 3 mm, 4 mm, 5 mm, 6 mm, 7 mm, 8 mm, 9 mm, or 10 mm in diameter.

Further disclosed are three-dimensional (3D) textile structures, such as the example shown in FIG. 7. Such 3D textile structure may comprise the same or similar material compositions as the 2D structures. In specific embodiments, 3D textile structures may comprise the described plastic fibers and may additionally comprise one or more reinforcing glass fibers tows. The through-thickness (TT) interlock structure may comprise a welt, warp, and binder all made of the described plastic fibers, with the addition of separate glass fiber tows, or a combination thereof.

The 2D or 3D recycled plastic woven textile structures may be manually woven, woven on a mandrel, 3D printed, or constructed using a similar methodology, to create variations upon the above-mentioned shapes.

The addition of either 2D or 3D woven textile to concrete may improve the strength of the concrete, as well as the tensile, toughness, and deformation performance of the concrete. Concrete structures containing the aforementioned recycled plastic 2D or 3D woven structures may exhibit improved flexural strength due to the high modulus of elasticity of the plastic fibers, allowing the concrete to be used in applications where frequent loading is observed, such as walkways, roadways, highway barriers, sidewalks, and driveways.

The woven textile structures may also be integrated in the form of continuous or discontinuous fibers, or as discontinuous fibers integrated into a non-woven structure or textile, or similar structures, which may improve the cracking resistance of a final concrete structure.

Additionally, the plastic may be printed as individual layers for use as either 2D or 3D shaped aggregate particles that may be incorporated into concrete as fillers, 3D printing applications, or similar applications. These structures may be injection molded, 3D printed, or fabricated using similar methods. The individual layers may then interlock together through mating posts, which may snap into the subsequent layer, or the individual layers interlock together weaving of the structure itself.

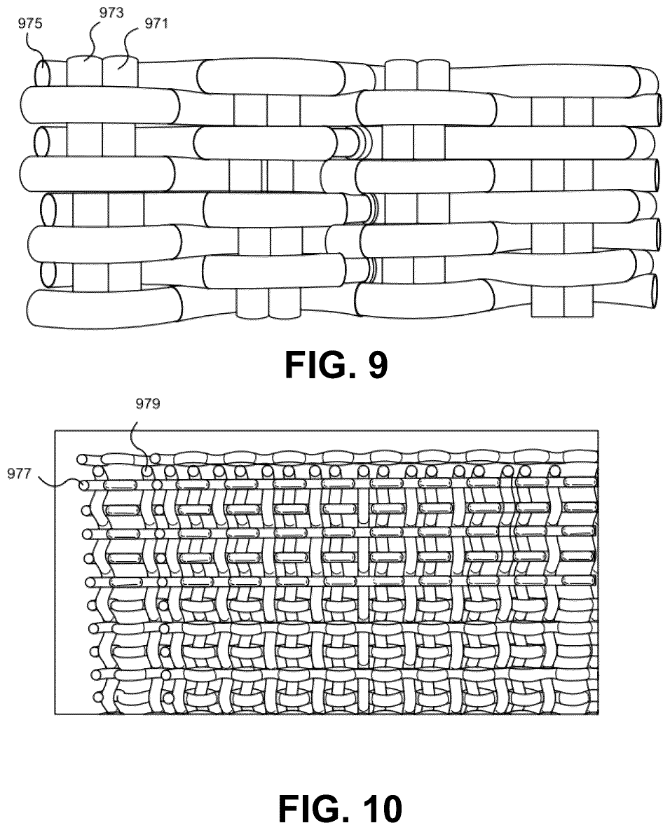

The plastic shaped aggregate particles may be incorporated in concrete, walkways, pavers, or paver-like products that may be either formed, pre-cast, 3D printed, made by hand, or using similar techniques. Specifically, the cement pavers with shaped aggregate particles may have a rectangular geometry with rounded corners to offset corner stresses, as shown in FIGS. 8 and 9. The sides may be straight or slightly tapered, giving a more rounded geometry, as shown in FIG. 8. The upper corners may have more rounded corners compared to the bottom corners, with slight tapering from top to bottom. Additionally, these pavers may either include a logo (e.g., MAA'VA) or pattern on top, or have an unfinished surface.

While particular dimensions and geometries are described as potential best embodiments, additional sizes, and shapes may be used.

Different plastics, combinations of plastics, and other materials have different temperature response characteristics. Different selections will be appropriate in applications with different environmental conditions such as fire risks, extreme temperature variation, ultra-low temperatures, etc.

While the use of a wide variety of shaped aggregate particles is common, we distinguish that we are particularly optimizing the shape (geometry) and spatial distribution (intercluding interlocking) of the shaped aggregate particles.

We note that examples of particular sizes, size-ranges, shapes, and materials represent our understanding of the preferred embodiment of our invention. We envision that variations in shape, size and material may be used in various circumstances.

We further note the synergistic use of these techniques along with carbon dioxide injection or other carbon sequestering techniques.

In methods of concrete preparation, these shaped aggregate particles may be mixed into the cement at random or in a designated order. The shaped aggregate particles may be of a uniform variety or may comprise a plurality of regular shapes, features, and/or sizes,

Thorough mixing of the cement may be used to provide an even distribution of the shaped aggregate particles in the cement. For the spherical, burst pattern, spiral, and ellipsoidal plastic shaped aggregate particles, or similar designs, this mixing effect may also increase the likelihood of the concrete exhibiting isotropic properties, as the shaped aggregate particles are stochastically distributed throughout the mixture. This may increase the likelihood that the resulting concrete exhibits a more uniform distribution of mechanical properties.

In embodiments, the shaped aggregated particles may be mixed with cement such that the shaped aggregated particles comprise from about 10% to about 25% (wt/wt) or from about 10% to about 50% of the resulting mixture. In particular embodiments, the shaped aggregated particles may be about 10%, 11%, 12%, 13%, 14%, 15%, 16%, 17%, 18%, 19%, 20%, 21%, 22%, 23%, 24%, 25%, 30%, 35%, 40%, 45%, or 50% (wt/wt) of the resulting mixture.

In embodiments, one or more of CaOH, CO₂, sand, silica byproduct, and/or water may be mixed with the cement and the shaped aggregate particles. The mixture comprising cement and shaped aggregate particles may then be molded into a final shape before curing to form a concrete.

Further described herein are concreates comprising shaped aggregate particles and a cement. In certain embodiments, the shaped aggregate particles may be randomly distributed throughout the concrete. In other embodiments, the shaped aggregate particles may be present in the concreate in a defined distribution or location. The shaped aggregate particles may be of a uniform variety or may comprise a plurality of regular shapes, features, and/or sizes,

In embodiments, the shaped aggregated particles comprise from about 10% to about 25% (wt/wt) or from about 10% to about 50% of the concrete. In particular embodiments, the shaped aggregated particles may be about 10%, 11%, 12%, 13%, 14%, 15%, 16%, 17%, 18%, 19%, 20%, 21%, 22%, 23%, 24%, 25%, 30%, 35%, 40%, 45%, or 50% (wt/wt) of the concrete.

In embodiments, the concrete further comprises one or more of CaOH, CO₂, sand, silica byproduct, and/or water. In embodiments, the concrete has been formed/molded prior to curing. For example, the concrete may be formed into one or more of brick, a paver, a countertop, a sink, a wall slab, a floor slab, a barricade, a coffee table, home good products such as candle sticks and bowls, and concrete lighting elements. In one embodiment, the concrete is in the form of a walkway material. In a further embodiment, the walkway material is a paver. In yet an additional embodiment the paver comprises one or more characteristics selected from the group consisting of a rectangular geometry, a rounded geometry, rounded corners, straight sides, tapered sides, and a logo embedded or stamped on the paver surface.

The cement, as described herein may have a compression strength of at least 1300PSI. IN particular embodiments, the cement has a compression strength of at least 100 PSI, 200 PSI, 300 PSI, 400 PSI, 500 PSI, 600 PSI, 700 PSI, 800 PSI, 900 PSI, 1000 PSI, 1100 PSI, 1200 PSI, 1300 PSI, 1400 PSI, 1500 PSI, 1600 PSI, 1700 PSI, 1800 PSI, 1900 PSI, 2000 PSI, 2500 PSI, 3000 PSI, 3500 PSI, 4000 PSI, 4500 PSI, 5000 PSI, 5500 PSI, 6000 PSI, 6500 PSI, 7000 PSI, 7500 PSI, 8000 PSI, 8500 PSI, 9000 PSI, 9500 PSI, or 10000 PSI.

### EXAMPLES

The present invention is further described in the following examples, which are offered by way of illustration and are not intended to limit the invention in any manner.

### Example 1. Manufacture of Plastic-Silica Shaped Aggregate Particle Spheres

Virgin nylon 6 plastic was shaped into spherical aggregate particles. Finned spheres were designed to maximize the interior and exterior surface area. The interior surfaces of the finned sphere approximate the exterior surface. Virgin nylon 6 (Formlabs) was prepared for shaping by mixing nylon 6 with silica (integrated, 10-500 micron suspended silica) at a 65%: 35% nylon: silica ratio. Nylon-silica mixture was prepared by using liquid nylon with suspended silica, which was mixed for 10 min. Prepared plastic was shaped into finned spheres of 0.5 mm (FIG. 1), 7.5 mm (FIG. 2), and 10 mm (FIG. 3) diameter via 3D printing [100-micron printing resolution at 30° C., standard pressure, and chemically post cured] (Formlabs Form 3BL).

The finned spheres are also fabricated by melting nylon 6 at 200-400° C. until viscous, incorporating 10-500 micron silica into the molten mixture, and stirring for 20 minutes until homogeneous. The nylon 6 with suspended silica is shaped into the finned spheres of 0.5 mm (FIG. 1), 7.5 mm (FIGS. 2), and 10 mm (FIG. 3) diameters via injection molding using die-cast molds.

### Example 2. Manufacture of Plastic-Silica Shaped Aggregate Particles

The plastic-silica aggregate particles can also be fabricated by melting nylon 6 at 300-400° C. until viscous, incorporating 10-500 micron silica into the molten mixture, and stirring for 20 minutes until homogeneous. The nylon 6 with suspended silica is then shaped into plastic-silica shapes via extrusion molding between 200-400° C. FIG. 6 extrusion methods for producing the aggregate particles. The plastic-silica is extruded, and portions are cut from the extrusion. In some embodiments, the aggregate particle 623 is tooth shaped, or arched shaped. In some embodiments, the aggregate particle 625 is flag shaped. In some embodiments, the aggregate particle is s-shaped or hook shaped. These shapes are produced as the plastic is extruded and cooled before cutting. Cooling the plastic before cutting leads to defined sides and edges. Aggregate particle 731 of FIG. 7 includes upper pyramid portion 733 which could be extruded in a cube shape and the spherical portion 735 is cut with a cutting device. A blade with an arc that is rotated will cut the sphere shape. The aggregate particle 737 would be extruded and cut with a blade for making curved cuts.

FIG. 8 includes several shapes that are formed by different extrusion and cutting techniques. Aggregate particle 841 would be formed when the plastic is extruded in a square and when the plastic is cooled the plastic is cut, forming a cube. Aggregate particle 843 would be formed as the hot plastic is extruded and cut. Faces 845 and 847 are created as a blade cuts from the top and a blade cuts from the bottom. The hot plastic deforms instead of cutting cleanly, this forms the pointed ends giving the rhomboid shape. Aggregate particle 851 would also be formed as the hot plastic is extruded and cut. Face 853 is created as a blade cuts from the top. The hot plastic deforms while cutting. Aggregate particle 861 includes wall 863 surrounding hole 865. The plastic would be extruded as a circle and forming the hole through the middle would be accomplished by placing a wire in the plastic. The wire is extruded with the plastic, in some embodiments, the wire is removed before the extrusion is cut. In other embodiments, the wire is cut by the blade that cuts the extruded plastic. In yet other embodiments, the hole may be formed by piercing the plastic of the aggregate after the extruded plastic has been cut. While holes in the aggregate particle are common in bead shapes, or round tubes, holes may be used to increase the surface area of other aggregate particle shapes.

Other aggregate particle shapes are formed through compression molding. The extruded plastic is cut, and a compression die pushes on the cut piece to form the aggregate particle shape. The compression dies can form the aggregate particles into many shapes. Each half of the finned spherical aggregate particles can be formed through compression molding. Many other shapes may also be formed through compression molding.

The aggregate particles can be shaped into rings, and the rings connected such as in FIG. 13. In some embodiments, the rings are connected in chains. In some embodiments, the rings are connected to form rings.

### Example 3. Manufacture of Plastic-Silica Spirals and Weaves

Recycled nylon 6 plastic is shaped into spherical, spiral, and weaved aggregate particles. Burst sphere, spirals, and weaves are designed to maximize interior and exterior surface area. Source plastic is acquired from shredded homogeneous nylon 6 recycled plastic waste (Direct Polymers, Denver, CO.) Plastic is prepared for shaping by mixing recycled nylon 6 with silica at a 65%: 35% nylon: silica ratio. Nylon-silica mixture is then prepared by melting the nylon to 300-400° C., adding 2-100 micron silica and mixing for 10 min. The prepared plastic is then shaped into Burst spheres (FIG. 4) and spirals (FIG. 5) via 3D printing.

The plastic-silica spirals are also fabricated by melting nylon 6 at 300-400° C. until viscous, incorporating 10-500 micron silica into the molten mixture, and stirring for 20 minutes until homogeneous. The nylon 6 with suspended silica is then shaped into plastic-silica spirals 5 to 25 mm in length and 2 to 20 mm in diameter via extrusion molding between 200-400° C.

The plastic-silica waves are also fabricated by melting nylon 6 at 300-400° C. until viscous, incorporating 10-500 micron silica into the molten mixture, and stirring for 20 minutes until homogeneous. The nylon 6 with suspended silica is then pultruded into long fibers 1 to 10 mm in diameter (FIG. 9). The fibers can be extruded as any of the shapes used in manufacturing the aggregate particles. Subsequently the fibers are used to construct plastic-silica weave structures via a 3D knitting process at room temperature. The weave can be constructed with one fiber 977 in a first direction and a second fiber 979 in a second perpendicular direction. In other embodiments, the weave is constructed with two fibers such as fibers 973 and 971 running in one direction and fiber 975 running in a perpendicular direction.

### Example 4. Concrete Formulation with Plastic Shaped Aggregate Particles

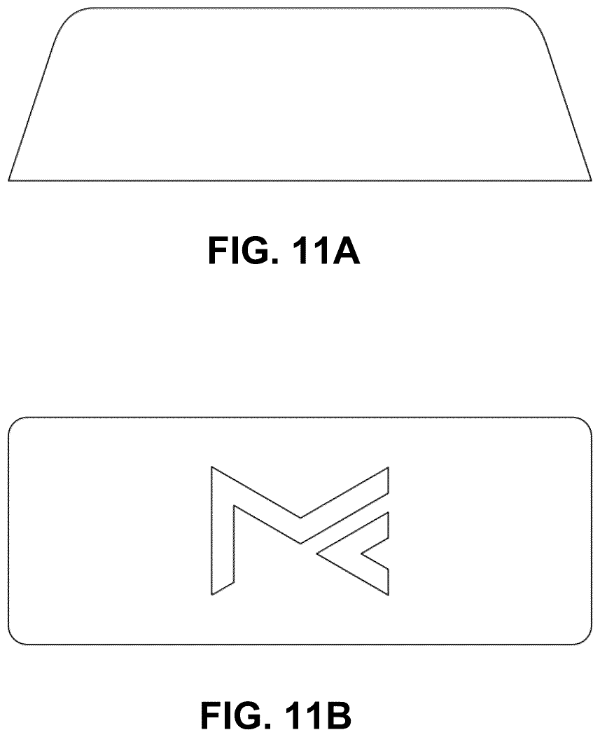

Concrete pavers (FIGS. 11A, 11B) were constructed using plastic aggregate particles concrete mix. Shredded homogeneous nylon 6 recycled plastic waste was mixed with cement (Table 1), CaOH [balanced form Ca(OH)₂], CO₂, sand (Quikrete, model 115251), and water (Table 2). The resulting concrete mix was mixed for 10 minutes then poured into molds shaped as walkway pavers approximately 6 inches X 2.5 inches X 3.25 inches. Paver molds were CO₂ cured for 2 hours at 20 PSI at 85-115° C. Additional formulations of plastic aggregate particles concrete are listed in Table 3. Samples were compression tested according to the ASTM C109/C109M standard.

Compression test results are listed in Table 3.

### Example 5. Concrete Formulation with Plastic-Silica Shaped Aggregate Particles

Concrete pavers (FIGS. 11A, 11B) were constructed using nylon-silica composite finned sphere concrete mix. An equal mixture (1:1:1) of nylon-silica composite finned spheres (0.5 mm: 7.5 mm: 10 mm) of Example 1 was mixed with cement, CaOH, CO₂, sand, and water as described previously in Example 3. The resulting concrete mix was poured into molds, cured, and tested as described previously in Example 3. Additional formulations of nylon-silica composite finned sphere concrete are listed in Table 3.

The compression strength of plastic aggregate particles pavers of Example 4 was then compared to pavers (FIG. 1l ) constructed with nylon-silica composite finned sphere concrete mix of this Example 4 (paver made with the plastic-silica spheres of Example 1. Compression test results are listed in Table 3. [The engineered plastic-silica shaped aggregate particles outperformed crushed plastic by nearly 2-fold, with a final compression strength of 5800 for the concrete with 40% plastic-silica shaped aggregate particles vs. 2900 for 40% standard, finely ground plastic. Therefore, this engineering plastic morphology and composition allow for a high compressive strength when integrated into concrete with a cement binder under CO₂ curing]

### Example 6. Concrete Formulation with Plastic-Silica Weaves

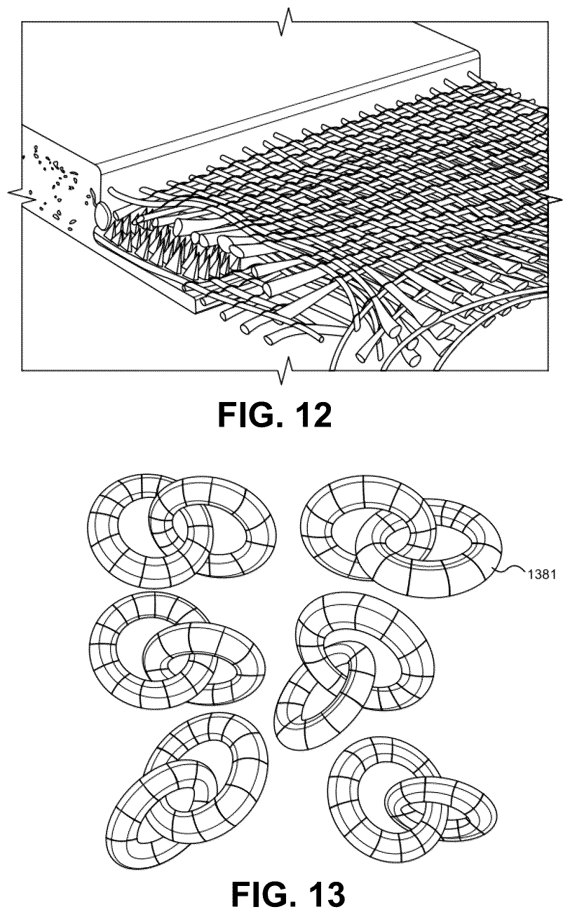

Concrete pavers and other concrete forms can be constructed with plastic weave. FIG. 12 shows multiple layers of weave being incorporated into concrete forms. The concrete is laid down and the weave placed on top. Concrete will then be poured over the weave layers.

TABLE 1
Cement

| Lime (CaO) | 65% [mass %] |
|---|---|
| Silica (SiO2) | 15 to 20% |
| Alumina (Al2O3) | 5% |
| Iron oxide (Fe2O3) | 0.5 to 6% |
| Magnesia (MgO) | 0.1 to 4% |
| Separately added → Hydrated lime, Ca(OH)2 | 10% |

TABLE 2
Concrete mix

| Parameter | Value % by volume |
|---|---|
| Plastic aggregate particles | 40 |
| Cement | 18 |
| CaOH [Ca(OH)₂] | 15 |
| CO2 | 0.01 |
| Sand | 17 |
| Water | 10 |

TABLE 3
Test - ASTM C109/C109M

| | | % Plastic | | | | |
|---|---|---|---|---|---|---|
| | | aggregate | Paver | Paver | Paver | Compression |
| | Plastic | particles in | Width | Height | Area | strength |
| Plastic morphology | composition | concrete | (in.) | (in.) | (Sq. in.) | (PSI) |
| Crushed plastic (large) | PP | 3% | 2 | 2 | 4 | 1600 |
| Crushed plastic (large) | PP | 6% | 2 | 2 | 4 | 1300 |
| Crushed plastic (large) | PP | 40% | 2 | 2 | 4 | — |
| Crushed plastic (large) | PVC | 3% | 2 | 2 | 4 | 6780 |
| Crushed plastic (large) | PVC | 6% | 2 | 2 | 4 | 3100 |
| Crushed plastic | N6 | 3% | 2 | 2 | 4 | 1500 |
| Crushed plastic | N6 | 6% | 2 | 2 | 4 | 1290 |
| Crushed plastic (large) | Mixed | 3% | 2 | 2 | 4 | 4370 |
| Crushed plastic (large) | Mixed | 6% | 2 | 2 | 4 | 3000 |
| Crushed plastic (finely | Mixed | 3% | 2 | 2 | 4 | 6780 |
| ground to <1 mm) | | | | | | |
| Crushed plastic (finely | Mixed | 40% | 2 | 2 | 4 | 2900 |
| ground to <1 mm) | | | | | | |
| Plastic-silica | CA | 40% | 2 | 2 | 4 | 5882 |
| aggregate particles | | | | | | |
| (finned sphere) | | | | | | |
| Plastic-silica | CA | 40% | 1 | 2 | 2 | 4790 |
| aggregate particles | | | | | | |
| (finned sphere) | | | | | | |

Table 3 legend: Nylon 6 (N6), non-homogeneous plastic (mixed), polypropylene (PP), polyvinyl chloride (PVC), no silica (NS), custom nylon-silica aggregate (CA).

All references, including publications, patents, and patent applications, cited herein are hereby incorporated by reference to the same extent as if each reference were individually and specifically indicated to be incorporated by reference and were set forth in its entirety herein.

While this invention has been described in certain embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### REFERENCES

1. Saikia, Nabajyoti, and Jorge De Brito. “Use of plastic waste as aggregate in cement mortar and concrete preparation: A review.” Construction and Building Materials 34 (2012): 385-401.
2. Ismail, Zainab Z., and Enas A. Al-Hashmi. “Use of waste plastic in concrete mixture as aggregate replacement.” Waste management 28.11 (2008): 2041-2047.
3. Mohammed, Azad A., Ilham I. Mohammed, and Shuaaib A. Mohammed. “Some properties of concrete with plastic aggregate derived from shredded PVC sheets.” Construction and Building Materials 201 (2019): 232-245.
4. Alqahtani, Fahad K., et al. “Novel lightweight concrete containing manufactured plastic aggregate.” Construction and Building Materials 148 (2017): 386-397.
5. Choi, Yun-Wang, et al. “Effects of waste PET bottles aggregate on the properties of concrete.” Cement and concrete research 35.4 (2005): 776-781.
6. Basha, Shaik Inayath, et al. “Mechanical and thermal properties of lightweight recycled plastic aggregate concrete.” Journal of Building Engineering 32 (2020): 101710.
7. Sambhaji, Patil Pramod. “Use of waste plastic in concrete mixture as aggregate replacement.” International Journal of Advanced Engineering Research and Science 3.12 (2016): 236956.
8. https://www.arqlite.com/site/construction

1. A composition comprising:
a plurality of shaped aggregate particles distributed within a cement;
wherein each shaped aggregate particle comprises a regular shape with one or more features providing additional surface area, and
wherein the shaped aggregate particles comprise a plastic.

2. (canceled)

3. The composition of claim 2, wherein the plastic is selected from the group consisting of PVC, HDPE, epoxy, polyester/PET, and nylon.

4. The composition of claim 1, wherein the shaped aggregate particles further comprise glass fiber, glass particles, silica, or any combination thereof.

5. The composition of claim 1, wherein the shaped aggregate particles comprise at least about 65% plastic.

6. (canceled)

7. The composition of claim 1, wherein the shaped aggregate particles further comprise at least 25% silica.

8. (canceled)

9. The composition of claim 1, wherein the regular shape is selected from the group consisting of a sphere, a cylinder, a pyramid, a cube, a spiral, an ellipsoid, a spherical burst pattern, a star, a fiber, and any combination thereof.

10. The composition of claim 9, wherein the one or more features providing additional surface area is a fin, a rib, a twist, a bend, a ridge, a valley, or a weave.

11. The composition of claim 8, wherein the shaped aggregate particles comprise a hollow core and at least one opening capable of permitting cement to enter the hollow core.

12. The composition of claim 1, wherein the shaped aggregate particles have an increased surface area ratio as compared to the regular shape of at least 1.2×, at least 1.5×, at least 2×. at least 2.2× or at least 2.5×.

13.-29. (canceled)

30. The composition of 1, wherein the shaped aggregate particles comprise between about 10% to about 50% of the composition (wt/wt).

31. The composition of claim 1, wherein the composition comprises between about 10% to about 25% cement.

32. The composition of claim 1, wherein the composition further comprises one or more of CaOH, CO₂, sand, silica byproduct and water.

33. The composition of claim 1, wherein the shaped aggregate particles are distributed randomly throughout the cement mixture.

34. (canceled)

35. (canceled)

36. The composition of claim 1, wherein the composition has a compression strength of at least 1300 PSI.

37. The composition of claim 1, wherein the shaped aggregate particles comprise a plurality of different shapes.

38. The composition of claim 1, wherein the shaped aggregate particles comprise a plurality of different sizes

39. The composition of claim 1, wherein the shaped aggregate particles comprise a plurality of different shapes and different sizes.

40.-43. (canceled)

44. A method for producing the composition of claim 1 comprising:
mixing a plurality of the shaped aggregate particles with a cement mixture, wherein the cement mixture comprises cement and one or more additional components.

45. The method of claim 44, wherein the shaped aggregate particles are formed by injection molding, compression molding, weaving, pultrusion, knitting, extrusion, printing or 3D printing.

46. The method of claim 44, wherein the mixing distributes the shaped aggregate particles randomly throughout the cement mixture.

47. (canceled)

48. (canceled)
